(19) United States
(12) Patent Application Publication
(10) Pub. No.: US 2011/0070861 A1
(43) Pub. Date: Mar. 24, 2011

(54) XML Protocol For The CMSP Gateway To CBC Interface In The CMAS Architecture

(75) Inventors: Brian K. Daly, Seattle, WA (US); DeWayne A. Sennett, Redmond, WA (US); Charles Musgrove, Henderson, NV (US)

(73) Assignee: AT&T MOBILITY II LLC, Atlanta, GA (US)

(21) Appl. No.: 12/564,624

(22) Filed: Sep. 22, 2009

(51) Int. Cl. H04M 11/04; H04W 4/00

(52) U.S. Cl. 455/404.1; 455/422.1

(57) ABSTRACT

An Extensible Markup Language (XML)-based protocol is utilized for communications between a Cellular Broadcast Entity (CBE) and a Cellular Broadcast Center (CBC) in a Commercial Mobile Alert System (CMAS) architecture. The CMAS architecture supports commercial mobile alerts, and the protocol provides a mechanism for Emergency Alert System (EAS) messages and related information to be communicated between the CBE and the CBC. In an example configuration, the protocol accommodates request messages from the CBE to the CBC and response messages from the CBC to the CBE. The request messages can provide an indication to initiate a message broadcast, update a previous message broadcast, or cancel a previous message broadcast. The response messages can provide an indication that the request message is valid, or an error message indicating that the request message is invalid.

### BACKGROUND

The Emergency Alert System (EAS) enables federal, state, and/or local governments to provide timely messages and alerts to the public regarding various types of emergencies. For example, the public can receive messages pertaining to weather conditions, disasters, AMBER (America's Missing: Broadcast Emergency Response) alerts, and the like. The EAS is jointly administered by the Federal Communications Commission (FCC), the Federal Emergency Management Agency (FEMA), and the National Weather Service (NWS).

EAS alert messages can be issued nationally (i.e., across the entire United States) or within a specific geographic region within the United States. For example, an EAS alert message can be issued for a specific area affected by a natural disaster, such as a hurricane or a flood. The area covered by the alert may span a portion of one or more states, and may cover tens or even hundreds of square miles depending on the type and severity of the emergency.

EAS alert messages are generally communicated via radio and television broadcasts. However, other types of communication mediums (e.g., cellular networks, local wireless networks, the Internet, cable networks, etc.) have been contemplated.

### SUMMARY

Protocols for communications in a Global System for Mobile Communications (GSM) and/or Universal Mobile Telephone System (“UMTS”) communications network are described. More specifically, in an example embodiment, Extensible Markup Language (XML)-based protocols for interfacing a Cellular Broadcast Entity (CBE) with a Cellular Broadcast Center (CBC) in GSM and/or UMTS networks are described. In at least one embodiment, the communications include Emergency Alert System (EAS) messages, and the protocol is applied to the EAS messages.

### BRIEF DESCRIPTION OF THE DRAWINGS

FIG. 1 is a diagram of an example GSM communications network in which embodiments of the CBE-CBC protocol can be implemented.

FIG. 2 is a diagram of an example UMTS communications network in which embodiments of the CBE-CBC protocol can be implemented.

FIG. 3 is a flow diagram of a process depicting an example valid call flow between a CBE and a CBC.

FIG. 4 is a flow diagram of a process depicting an example invalid call flow between a CBE and a CBC.

FIG. 5 is a depiction of an example CBE message (CBEM) object model.

FIG. 6 depicts a block diagram of an exemplary packet-based mobile cellular network environment, such as a GPRS network, in which communications between a CBE and a CBC in accordance with an XLM-based protocol can be implemented.

FIG. 7 illustrates an architecture of a typical GPRS network in which communications between a CBE and a CBC in accordance with an XLM-based protocol can be implemented.

FIG. 8 illustrates an exemplary block diagram view of a GSM/GPRS/IP multimedia network architecture within which communications between a CBE and a CBC in accordance with an XLM-based protocol can be implemented.

### DETAILED DESCRIPTION OF ILLUSTRATIVE EMBODIMENTS

In an example embodiment, an Extensible Markup Language (XML)-based protocol is utilized for communications between a Cellular Broadcast Entity (CBE) and a Cellular Broadcast Center (CBC) in a Commercial Mobile Alert System (CMAS) architecture. The CMAS architecture supports commercial mobile alerts. The CBE is a new entity in the CMAS architecture. The CBE receives alert messages from the Federal Alert Gateway and interfaces to (communicates with) the CBC. The CMAS architecture can be implemented in various communications networks, such as a Global System for Mobile Communications (GSM) communications network and a Universal Mobile Telephone System (UMTS) communications network, for example. It is to be understood, that the herein-described protocol is not limited to applications in a CMAS architecture, but can be utilized by any appropriate general commercial cellular broadcast service. In an example embodiment, a CBE is the server, processor, or the like, that creates the message content that is to be broadcast by the Cell Broadcast Service. The CBE may be owned by the wireless operator or may be owned and operated by an external information source (e.g., news, traffic, weather, stocks, sports highlights, sports scores). In addition to the message content to be broadcast, the CBE can provide the general characteristics for the message broadcast such as number of times to repeat the broadcast, amount of time between broadcasts, and target area to receive the broadcast. In an example embodiment, the CBC is the server, processor, or the like, within the wireless operator network which controls and manages the broadcast of messages via Cell Broadcast. The CBC receives messages for broadcast from multiple CBEs and coordinates the broadcast of these messages among multiple cell sites. The CBC determines the set of cell sites in the target area specified in the message received from the CBE. The CBC manages the broadcast period and frequency based upon the instructions received from the CBE. The CBC manages multiple simultaneous message broadcasts among numerous cell sites via multiple GSM Base Station Controllers (BSCs) and UMTS Radio Network Controllers (RNCs).

Utilization of the herein-described CBE-CBC protocol can provide for ease of operation of the CMAS architecture and can facilitate interoperability in a multi-vendor and/or multi-provider environment. Utilization of the herein-described CBE-CBC protocol can simplify interoperability testing and mitigate, if not prevent, any need to build proprietary interfaces and perform interoperability testing with multiple vendors to ensure proper system operations. Utilization of the herein-described CBE-CBC protocol can aid in developing FCC compliant communications systems. Additionally, utilization of the herein-described CBE-CBC protocol can facilitate flexible designs consistent with the use of various types of servers being deployed within a network.

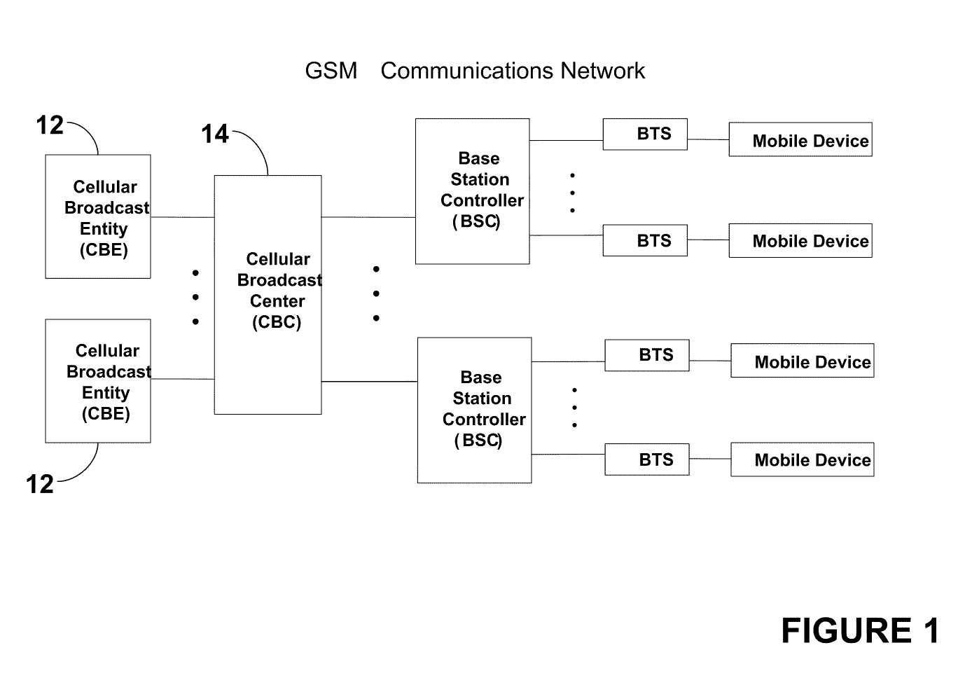

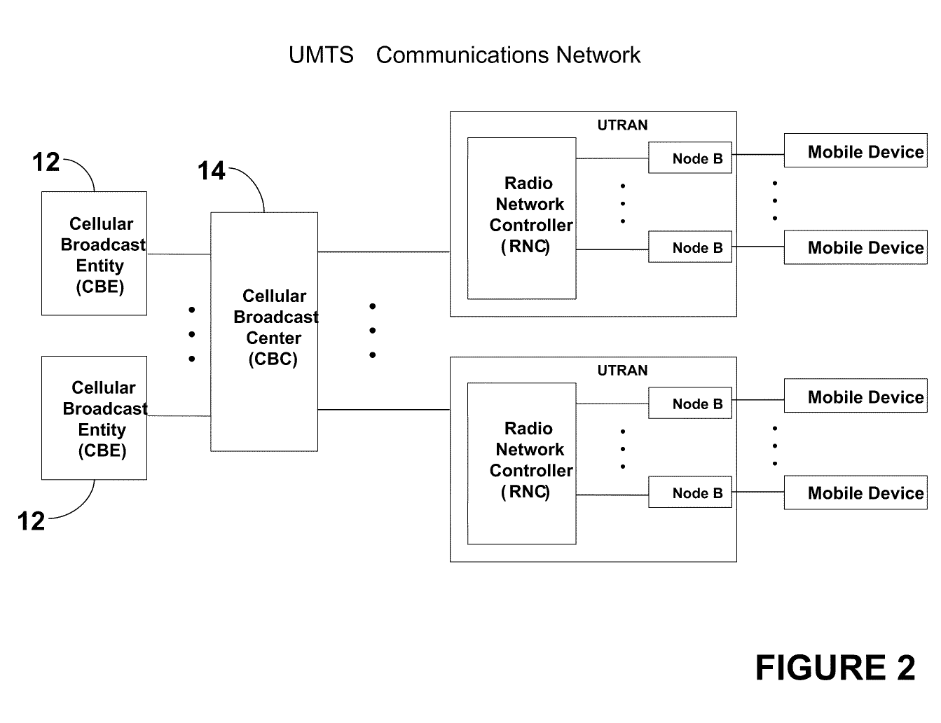

FIG. 1 is a diagram of an example GSM communications network in which embodiments of the CBE-CBC protocol can be implemented. FIG. 2 is a diagram of an example UMTS communications network in which embodiments of the CBE-CBC protocol can be implemented. Referring to FIG. 1 and FIG. 2, the CBE 12 receives alert messages from the Federal Alert Gateway, or the like, and interfaces to (communicates with) the CBC 14 in the GSM/UMTS networks depicted in FIG. 1 and FIG. 2. In an example embodiment, the CBE-CBC protocol utilizes an XML schema for communications between the CBE 12 and the CBC 14. In various embodiments, the XML schema is written to accommodate general cellular broadcast applications other than CMAS communications. Generally, the schema defines a CBC Request message sent from the CBE 12 to the CBC 14, and contains the information required by the CBC 14 to broadcast the alert message, including the actual message contents and information such as repetition period, how long to broadcast, etc. The CBC 14 receives this alert message and uses the information to construct a GSM/UMTS Cellular Broadcast primitive to be delivered to the BSC and/or RNCs, as shown in FIG. 1 and FIG. 2. The XML schema also defines a response message wherein the CBC 14 can inform the requesting entity, such as the CBE 12, that the message was accepted and delivered, or an appropriate error indication. The XML schema also defines a method to update a previously issued alert message.

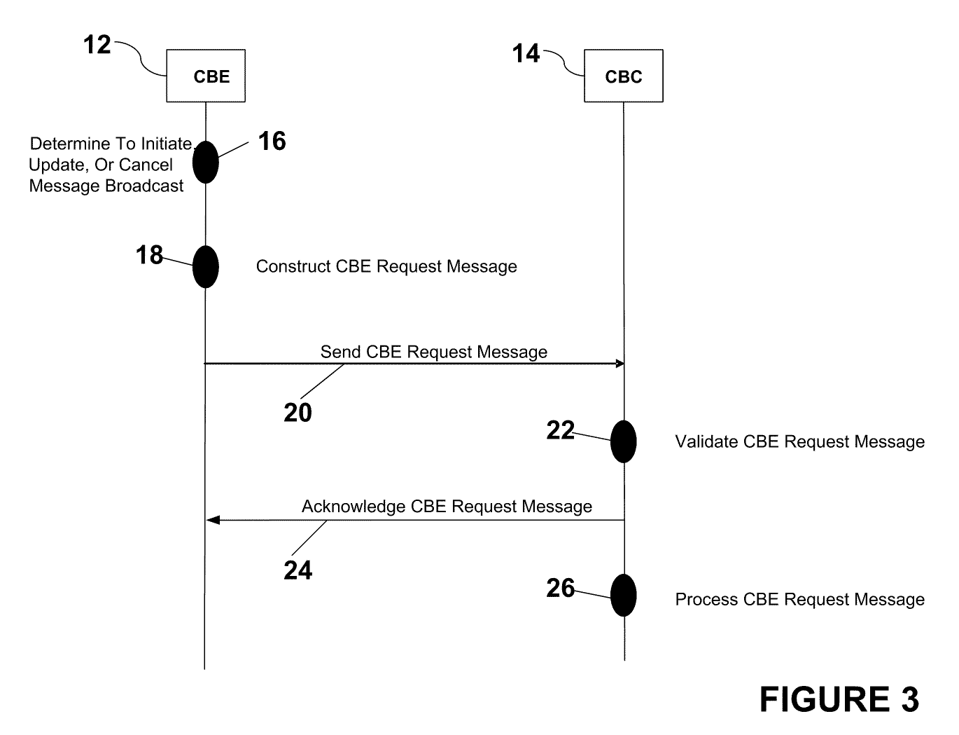

FIG. 3 is a flow diagram of a process depicting an example valid call flow between a CBE and a CBC. At step 16, the CBE 12 determines to initiate the broadcast of a cellular broadcast message, update the broadcast of a previous cellular broadcast message, or cancel the broadcast of a previous cellular broadcast message. In an example embodiment, the cellular broadcast message contains an EAS alert message and/or associated information. For example, for emergency alerts, the CBE is the CMAS Alert Gateway which will receive emergency alert messages from the Federal government Federal Alert Gateway. The majority of these alerts are initiated by the National Weather Service based upon severe weather conditions such as tornados, flash floods, etc. Updates of these alert messages could be issued for National Weather Service for changes in the severe weather conditions (e.g., tornado movement). Any time that the National Weather Service determines that an emergency alert is no longer needed or if an emergency alert was issued in error, a Cancel message could be issued. At step 18, the CBE 12 constructs a CBE to CBC request message in accordance with its determination at step 16. Thus, at step 18, the CBE 12 constructs one of a CBE to CBC initial request message, a CBE to CBC update request message, or a CBE to CBC cancel request message. More particularly, if, at step 16, the CBE 12 determines to initiate the broadcast of a cellular broadcast message, at step 18, the CBE 12 constructs a CBE to CBC initial request message. If, at step 16, the CBE 12 determines to update the broadcast of a previous cellular broadcast message, the CBE 12, at step 18, constructs a CBE to CBC update request message. And, if at step 16, the CBE 12 determines to cancel the broadcast of a previous cellular broadcast message, the CBE 12, at step 18, constructs a CBE to CBC cancel request message.

At step 20, the CBE 12 sends the CBC request message, constructed at step 18, to the CBC 14. More particularly, if, at step 18, the CBE 12 constructed a CBE to CBC initial request message, the CBE 12 sends the CBE to CBC initial request message to the CBC 14 at step 20. If, at step 18, the CBE 12 constructed a CBE to CBC update request message, the CBE 12 sends the CBE to CBC update request message to the CBC 14 at step 20. And, if at step 18, the CBE 12 constructed a CBE to CBC cancel request message, the CBE 12 sends the CBE to CBC cancel request message to the CBC 14 at step 20.

The CBC 14 validates the received CBE to CBE request message at step 22. Example types of message validation performed by the CBC include (1) validation of proper message structure and element format, (2) element values are with the ranges defined for the protocol, (3) verification that mandatory elements are present, and (4) verification that conditional elements are present as required based upon the contents of other elements. If validation passes (is successful) at step 22, the CBC 14 acknowledges the received CBE to CBC request message at step 24. That is, the CBC 14 sends an indication of acknowledgement and validation to the CBE 12.

At step 26, the CBC 14 processes the CBE to CBC request message and sends the acknowledgement to the CBE 12 at step 24. The CBC can process the request message in various ways. Examples include: (1) determination of set of cell sites for the message broadcast based upon the geo-targeting information in the message, (2) determination of the set of BSCs and RNCs which are to be associated with this message broadcast, (3) calculation of Cell Broadcast repetition period and frequency periods, (4) formatting of the received CBE to CBC message into Cell Broadcast parameters and message contents, and/or (5) sending the created Cell Broadcast parameters and message contents to the determined set of cell sites via the associated set of BSCs and RNCs.

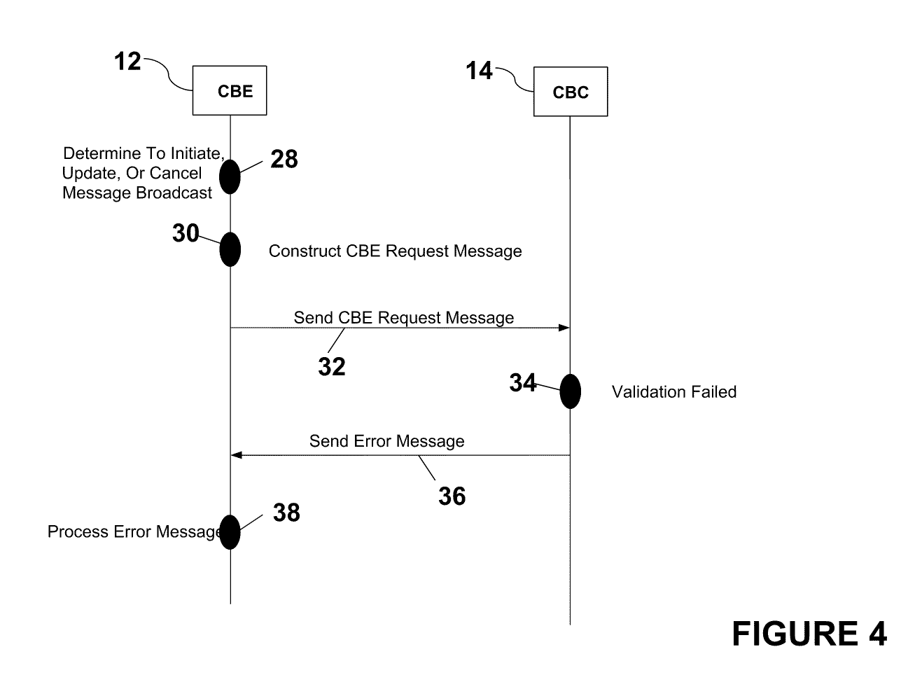

FIG. 4 is a flow diagram of a process depicting an example invalid call flow between a CBE and a CBC. At step 28, the CBE 12 determines to initiate the broadcast of a cellular broadcast message, update the broadcast of a previous cellular broadcast message, or cancel the broadcast of a previous cellular broadcast message. In an example embodiment, the cellular broadcast message contains an EAS alert message and/or associated information. For example, for emergency alerts, the CBE is the CMAS Alert Gateway which will receive emergency alert messages from the Federal government Federal Alert Gateway. The majority of these alerts are initiated by the National Weather Service based upon severe weather conditions such as tornados, flash floods, etc. Updates of these alert messages could be issued for National Weather Service for changes in the severe weather conditions (e.g., tornado movement). Any time that the National Weather Service determines that an emergency alert is no longer needed or if an emergency alert was issued in error, a Cancel message could be issued. At step 30, the CBE 12 constructs a CBE to CBC request message in accordance with its determination at step 28. Thus, at step 30, the CBE 12 constructs one of a CBE to CBC initial request message, a CBE to CBC update request message, or a CBE to CBC cancel request message. More particularly, if, at step 28, the CBE 12 determines to initiate the broadcast of a cellular broadcast message, at step 30, the CBE 12 constructs a CBE to CBC initial request message. If, at step 28, the CBE 12 determines to update the broadcast of a previous cellular broadcast message, the CBE 12, at step 30, constructs a CBE to CBC update request message. And, if at step 28, the CBE 12 determines to cancel the broadcast of a previous cellular broadcast message, the CBE 12, at step 30, constructs a CBE to CBC cancel request message.

At step 32, the CBE 12 sends the CBC request message, constructed at step 30, to the CBC 14. More particularly, if, at step 30, the CBE 12 constructed a CBE to CBC initial request message, the CBE 12 sends the CBE to CBC initial request message to the CBC 14 at step 32. If, at step 30, the CBE 12 constructed a CBE to CBC update request message, the CBE 12 sends the CBE to CBC update request message to the CBC 14 at step 32. And, if at step 30, the CBE 12 constructed a CBE to CBC cancel request message, the CBE 12 sends the CBE to CBC cancel request message to the CBC 14 at step 32.

The CBC 14 attempts to validate the received CBE to CBE request message at step 34. Example types of message validation performed by the CBC can include: (1) validation of proper message structure and element format, (2) element values are with the ranges defined for the protocol, (3) verification that mandatory elements are present, and/or (4) verification that conditional elements are present as required based upon the contents of other elements. If validation fails (is unsuccessful) at step 34, the CBC 14 sends an error response message at step 36. That is, the CBC 14 sends an indication that the attempt to valid the request message failed to the CBE 12.

At step 38, the CBE 12 processes the error message. Examples of how the CBE can process the error message include: (1) determination of set of cell sites for the message broadcast based upon the geo-targeting information in the message, (2) determination of the set of BSCs and RNCs which are to be associated with this message broadcast, (3) calculation of Cell Broadcast repetition period and frequency periods, (4) formatting of the received CBE to CBC message into Cell Broadcast parameters and message contents, and/or (5) sending the created Cell Broadcast parameters and message contents to the determined set of cell sites via the associated set of BSCs and RNCs.

In accordance with the XML protocol utilized to communication between the CBE and the CBC, the messages communicated between the CBE and the CBC, in an example embodiment, can comprise segments. Table 1 below contains a description of the exemplary CBE message segments. Each CBE to CBC message comprises a <CBEM_CBS_Request> segment, which may contain one <CBEM_CBS_Message_Info> segment and one or more <CBEM_CBS_Geotargeting_Info> segments. The CBEM_CBS_Request segment provides the elements that are used for management and handling of the CBEM message on the CBE to CBC interface including items such as message identifier, identification of sender, protocol version, type of CBEM message, etc. The CBEM_CBS_Request segment is required for all message type.

The CBEM_CBS_Message_Info provides additional information for initial message request and for update requests. This additional information is not required for all message types and therefore is contained in a separate segment. The additional information includes elements such as the message content, language indicators, repetition period, and number of rebroadcasts.

The CBEM_CBS_Geotargeting_Info segment defines the target area for the message. This additional information is not required for all message types and therefore is contained in a separate segment. Also since there can be multiple target areas defined for a specific message, the geo-targeting information is provided as a separate segment so that multiple occurrences of the geo-targeting information can be supported.

TABLE 1
CBE MESSAGE SEGMENTS

| CBE MESSAGE | CBE MESSAGE SEGMENTS |
|---|---|
| CBE to CBC Initial | one <CBEM_CBS_Request> segment |
| Request Message | one <CBEM_CBS_Message_Info> segment |
| | one or more <CBEM_CBS_Geotargeting_Info> |
| | segments |
| CBE to CBC Update | one <CBEM_CBS_Request> segment |
| Request Message | one <CBEM_CBS_Message_Info> segment |
| | one or more <CBEM_CBS_Geotargeting_Info> |
| | segments |
| CBE to CBC Cancel | one <CBEM_CBS_Request> segment |
| Message | |
| Acknowledgement | one <CBEM_CBS_Request> segment |
| Response for CBE to | |
| CBC Message | |
| Error Response for | one <CBEM_CBS_Request> segment |
| CBE to CBC | |
| Message | |

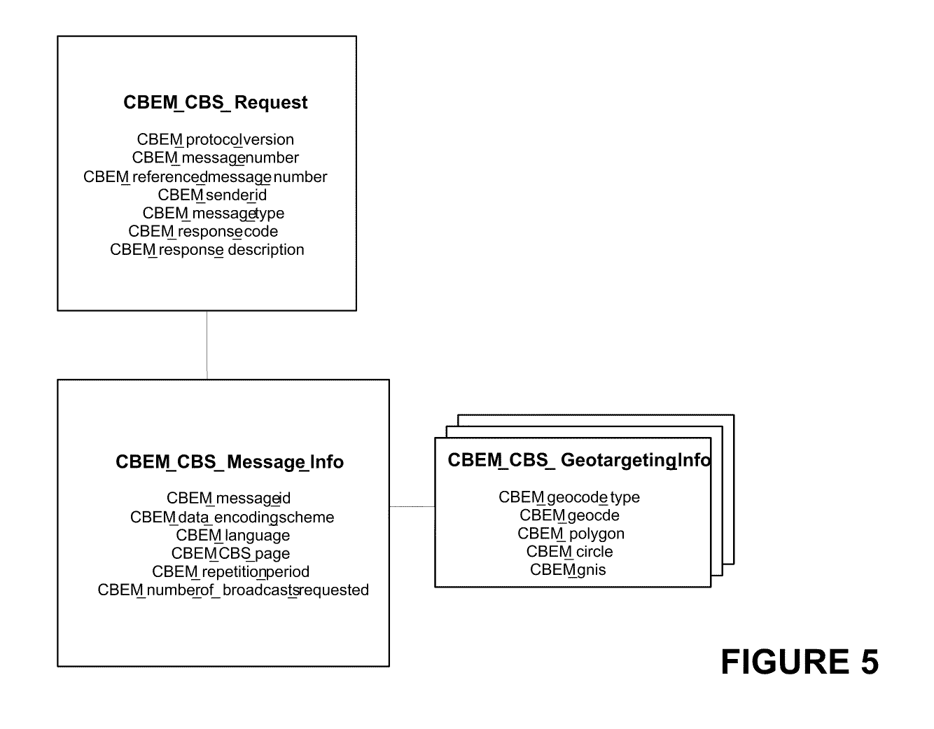

FIG. 5 is a depiction of an example object model for CBE messages. The object model depicted in FIG. 5 represents the objects (or elements) of the XML protocol utilized for communication between the CBE and the CBC. The elements shown in the DBE message object model depicted in FIG. 5 are described in detail in Table 2, Table 3, and Table 4 below. In the tables, an element is indicated as being: mandatory with an upper case letter M, conditional with an upper case letter C, or optional with an upper case letter O. It is to be understood, however, that the characteristics of mandatory, conditional, and optional, as shown in the table below for the respective elements is exemplary, and not intended to be limiting. A mandatory element is required when the associated segment is included in the CBE message. An optional element may be included in a segment. The entry in the Definition column defines when the element is optional and the interpretation of the missing optional element. A conditional element may be required in the segment depending on the contents of other elements.

Table 2 below describes example elements of the CBEM_CBS_Request segment.

TABLE 2
CBEM_CBS_REQUEST SEGMENT ELEMENT DESCRIPTION

| | MANDATORY/ | |
|---|---|---|
| | OPTIONAL/ | |
| CBEM ELEMENT | CONDITIONAL | DEFINITION |
| CBEM_CBS_Request | M | Identifies the segment with elements described in |
| | | the following rows of this table. |
| | | (1) Surrounds CBEM CBS Request segment sub- |
| | | elements. |
| | | (2) Must include the xmlns attribute referencing the |
| | | CBEM URN as the |
| | | namespace, e.g.: |
| | | <cbem:CBEM_CBS_Request |
| | | xmlns:cbem=“urn:xxx:xxxxx:xx:cbem:1.0”> |
| | | [sub-elements] |
| | | </cbem:CBEM_CBS_Request> |
| | | (3) In addition to the specified sub-elements, may |
| | | contain one or more |
| | | <CBEM_CBS_Message_Info> blocks. |
| CBEM_protocol_version | M | The version of the CBEM protocol. |
| | | Used by the CBE and the CBC to identify the |
| | | protocol version of the CBEM protocol. |
| | | The value of the CBEM_protocol_version element |
| | | for this version of the standard shall be 1.0. |
| CBEM_message_number | M | Identifies the unique message number of the |
| | | message. This will be used by the CBC to |
| | | generate the Serial Number parameter in the |
| | | CBC Write-Replace indication. |
| | | CBEM_message_number is a string uniquely |
| | | identifying the message. The |
| | | CBEM_message_number is assigned by the |
| | | CBE. |
| | | The value is assigned by the CBE, and may follow |
| | | the format: |
| | | <CBE Identifier>- <message number> |
| | | where |
| | | <CBE Identifier> is a unique string defined the |
| | | CBE and <message number> where <message |
| | | number> is the number assigned by the CBE to |
| | | this message. |
| | | The CBC shall be responsible for generating and |
| | | required mapping of the |
| | | CBEM_message_number to the CBC Serial |
| | | Number parameter. |
| CBEM_referenced_message_number | C | Identifies the referenced message number. This is |
| | | used for CBE Updates or Cancel message types |
| | | and is used by the CBC to associate the message |
| | | with the previous message to be updated or |
| | | cancelled. |
| | | CBEM_referenced_message_number is a string |
| | | uniquely identifying the message. The |
| | | CBEM_referenced_message_number is assigned |
| | | by the CBE. |
| | | The value is assigned by the CBE, and may follow |
| | | the format: |
| | | <CBE Identifier>- <message number> |
| | | where |
| | | <CBE Identifier> is a unique string defined by |
| | | the CBE and <message number> where |
| | | <message number> is the number assigned by the |
| | | CBE to this message. |
| CBEM_sender_id | M | URI or IP address of the CBE sending the CBEM |
| | | message. |
| CBEM_message_type | M | This element identifies the message type for the |
| | | request to the CBC. |
| | | Code Values: |
| | | “CBS Request” - A request to initiate a cell |
| | | broadcast message with the information |
| | | contained in the CBEM_CBS_Message_Info |
| | | segment |
| | | “CBS Update Request” - Updates and |
| | | supersedes the earlier message(s) identified in |
| | | <CBEM_referenced_message_number> |
| | | “CBS Cancel Request” - Cancels the earlier |
| | | message(s) identified in < CBEM_{—} referenced_{—} |
| | | message_{—} identifier> |
| | | “Ack” - Acknowledges receipt and acceptance of |
| | | the message(s) identified in |
| | | <CBEM_referenced_message_number> |
| | | “Error” indicates rejection of the message(s) |
| | | identified in < |
| | | CBEM_referenced_message_number>; |
| | | explanation should appear in |
| | | <CBEM_response_description> |
| CBEM_response_code | C | This element contains the CBEM Response Codes |
| | | (see clause 7.5 Definition of CBEM Response |
| | | Codes) that may be returned from the CBC to the |
| | | CBE in response to a received CBS request |
| | | message via the CBE to CBC interface. This |
| | | element is included when necessary based upon |
| | | specific use case. |
| | | Multiple instances may occur within a single |
| | | <CBEM_CBS_Request> block. Each occurrence |
| | | of the CBEM_response_code element should |
| | | have a corresponding occurrence of the |
| | | CBEM_response_description element. |
| CBEM_response_description | C | The CBC may use the CBEM_response_description |
| | | element to populate this element on messages |
| | | from the CBC to the CBE. (See clause 7.5 |
| | | Definition of CBEM Response Codes). |
| | | Multiple instances may occur within a single |
| | | <CBEM_CBS_Request> block. Each occurrence |
| | | of the CBEM_response_description element |
| | | should have a corresponding occurrence of the |
| | | CBEM_response_code element. |

Table 3 below describes example elements of the CBEM_CBS_Message_Info Segment.

TABLE 3
CBEM_CBS_MESSAGE_INFO SEGMENT ELEMENT DESCRIPTION

| | MANDATORY/ | |
|---|---|---|
| | OPTIONAL/ | |
| CBEM ELEMENT | CONDITIONAL | DEFINITION |
| CBEM_CBS_Message_Info | C | Identifies the segment with elements described in |
| | | the following rows of this table. |
| | | (1) Surrounds CBEM_CBS_Message_Info |
| | | segment sub-elements |
| | | (2) Only a single occurrence is permitted within a |
| | | single <CBEM_CBS_Request>. |
| | | (3) Required for a CBEM_message_type of CBS |
| | | Request and CBS Update Request. |
| CBEM_CBS_message_id | M | Identifies the Cell Broadcast message id of the |
| | | CBEM message. Code values are defined in 3GPP |
| | | TS 23.041. |
| CBEM_data_coding_scheme | M | Identifies the alphabet or coding employed for the |
| | | message characters. |
| | | Code Values: |
| | | “GSM_7_Bit_Coding” - Language using the |
| | | GSM 7 bit default alphabet |
| CBEM_language | M | Identifies the language of the information in the |
| | | CBS pages. |
| | | Code Values: |
| | | “English” |
| | | “Spanish” |
| | | “French” |
| | | “German” |
| | | “Italian” |
| | | “Dutch” |
| | | “Swedish” |
| | | “Danish” |
| | | “Portuguese” |
| | | “Finnish” |
| | | “Norwegian” |
| | | “Greek” |
| | | “Turkish” |
| | | “Hungarian” |
| | | “Polish” |
| | | “Czech” |
| | | “Hebrew” |
| | | “Arabic” |
| | | “Russian” |
| | | “Icelandic” |
| CBEM_CBS_page | M | Contains the information to be broadcast. |
| | | Information may be split across multiple Cell |
| | | Broadcast Service (CBS) pages of 82 octets |
| | | which is equivalent to 93 7-bit characters. |
| | | Multiple occurrences may occur. |
| | | Minimum of 1 CBS page is required. |
| | | Maximum of 15 CBS pages allowed. |
| CBEM_repetition_period | M | This specifies the repetition period for the CBS |
| | | message per 3GPP TS 23.041. |
| | | This indicates the period of time after which |
| | | broadcast of the CBS message should be |
| | | repeated. The minimum period with which a |
| | | CBS message consisting of one CBS page may |
| | | be broadcast over the air interface is a period of |
| | | 1.883 s. |
| | | The value of “Repetition-Period” shall be in the |
| | | range 1 to 1024 where each unit will represent |
| | | the value of one minimum period. |
| CBEM_number_of_broadcasts_requested | M | This specifies the number of times the CBS message |
| | | is to be broadcast per 3GPP TS 23.041. |
| | | CBEM_number_of_broadcasts_requested may take |
| | | any value up to 65535 (this maximum allows the |
| | | CBS message to be broadcast approximately |
| | | every 1.883 s for more than 24 h). If the |
| | | parameter is set to 0 then the CBS message will |
| | | be broadcast indefinitely (i.e. until the CBC |
| | | receives an appropriate cancel indication). |

Table 4 below describes example elements of the CBEM_CBS_Geotargeting_Info Segment.

TABLE 4
CBEM_CBS_GEOTARGETING_INFO ELEMENT DESCRIPTION

| | MANDATORY/ | |
|---|---|---|
| | OPTIONAL/ | |
| CBEM ELEMENT | CONDITIONAL | CBEM DEFINITION |
| CBEM_CBS_Geotargeting_Info | C | Identifies the segment with elements described in |
| | | the following rows of this table. |
| | | (1) Surrounds CBEM_CBS_Geotargeting_Info |
| | | segment sub-elements |
| | | (2) Multiple instances are permitted within a |
| | | single <CBEM_CBS_Message_Info>. |
| | | (3) Required for a CBEM_message_type of CBS |
| | | Request and CBS Update. |
| | | (4) At least one of the <CBEM_geocode>, |
| | | <CBEM_polygon>, <CBEM_circle>, or |
| | | <CBEM_gnis> elements must be included. |
| CBEM_geocode_type | C | Required if CBEM_geocode element is included. |
| | | Defines the type of encoding for the associated |
| | | CBEM_geocode element. |
| | | Code Values: |
| | | “CMAS” - CMAS geocode |
| | | “SAME” - NOAA National Weather Service |
| | | (NWS) Specific Area Message Encoding |
| | | (SAME) code |
| | | “FIPS” - Federal Information Processing |
| | | Standards (FIPS) code |
| | | “ZIP” - U. S. Postal Service ZIP code |
| CBEM_geocode | C | Required if CBEM_geocode_type element is |
| | | included. |
| | | The geographic code delineating the Cell |
| | | Broadcast Area using the encoding type as |
| | | defined in the CBEM_geocode_type element. |
| | | Geocode values for a geocode type of CMAS are |
| | | defined in the Joint ATIS/TIA CMAS Federal |
| | | Alert Gateway to CMSP Gateway Interface |
| | | Specification |
| | | Geocode values for a geocode type of FIPS are |
| | | defined in FIPS Publication 6-4 and is |
| | | available online at |
| | | http://www.itl.nist.gov/fipspubs/index.htm |
| | | Geocode values for a geocode type of SAME are |
| | | defined at |
| | | http://www.nws.noaa.gov/nwr/indexnw.htm#sametable |
| | | Values for a geocode type of ZIP are defined at |
| | | http://zip4.usps.com. |
| CBEM_polygon | C | The paired values of points defining a polygon |
| | | that delineates the Cell Broadcast Area. |
| | | Code Values: |
| | | The code values of the geographic polygon are |
| | | represented by a whitespace-delimited list of |
| | | WGS 84 coordinate pairs. |
| | | The first and last pairs of coordinates must be the |
| | | same. |
| | | It is recommended that the maximum number of |
| | | coordinate pairs be limited to 100. |
| CBEM_circle | C | The paired values of a point and radius |
| | | delineating the Cell Broadcast Area. |
| | | Code Values: |
| | | The circular area is represented by a central |
| | | point given as a WGS-84 coordinates pair |
| | | followed by a space character and a radius |
| | | value in kilometers. |
| CBEM_gnis | C | This value is the geographic code delineating the |
| | | Cell Broadcast Area using the U.S.G.S. |
| | | Geographic Names Information System |
| | | (GNIS) code as defined at |
| | | http://geonames.usgs.gov. |

The following is an example XML Schema for messages communicated between the CBE to CBC.

<?xml version = ″1.0″ encoding = ″UTF-8″?>
<schema xmlns = ″http://www.w3.org/2001/XMLSchema″

targetNamespace = ″cbem:1.0″
xmlns:cbem = ″cbem:1.0″
xmlns:xs = ″http://www.w3.org/2001/XMLSchema″
elementFormDefault = ″qualified″
attributeFormDefault = ″unqualified″>
<element name = ″CBEM_CBS_Request″/>
<annotation>
<documentation>CBEM_CBS_Request (version 1.0)</documentation>
</annotation>
<complexType>

<sequence>

<element name = ″CBEM_protocol_version″ type =

″string″/>

<element name = ″CBEM_sender_id” type = ″anyURI″/>
<element name = ″CBEM_message_number″ type = ″string″/>
<element name = ″CBEM_referenced_message_number″ type =

″string″

minOccurs = “0”/>

<element name = ″CBEM_message_type″>

<simpleType>

<restriction base = ″string″>

<enumeration value = ″CBS Request″/>
<enumeration value = ″CBS Update Request″/>
<enumeration value = ″CBS Cancel Request″/>
<enumeration value = ″Ack″/>
<enumeration value = ″Error″/>

</restriction>

</simpleType>

</element>
<element name = ″CBEM_response_code″ type = ″string″

minOccurs = ″0″

maxOccurs = “unbounded”/>

<element name = ″CBEM_response_description″ type =

″string″ minOccurs = ″0″

maxOccurs = “unbounded”/>

<element name = ″CBEM_CBC_Message_Info″ minOccurs = ″0″>

<complexType>

<sequence>

<element name = ″CBEM_CBS_message_id″ type =

″string″ />

<element name = ″CBEM_data_coding_scheme″>

<simpleType>

<restriction base = ″string″>

<enumeration value =

″GSM 7 Bit Coding″/>

</restriction>

</simpleType>

</element>
<element name = ″CBEM_language″>

<<simpleType>

<restriction base = ″string″>

<enumeration value = ″English″/>
<enumeration value = ″Spanish″/>
<enumeration value = ″French″/>
<enumeration value = ″German″/>
<enumeration value = ″Italian″/>
<enumeration value = ″Dutch″/>
<enumeration value = ″Swedish″/>
<enumeration value = ″Danish″/>
<enumeration value = ″Portuguese″/>
<enumeration value = ″Finnish″/>
<enumeration value = ″Norwegian″/>
<enumeration value = ″Greek″/>
<enumeration value = ″Turkish″/>
<enumeration value = ″Hungarian″/>
<enumeration value = ″Polish″/>
<enumeration value = ″Czech″/>
<enumeration value = ″Hebrew″/>
<enumeration value = ″Arabic″/>
<enumeration value = ″Russian″/>
<enumeration value = ″Icelandic″/>

</restriction>

</simpleType>

</element>
<element name = ″CBEM_CBS_page″ minOccurs = ″1″

maxOccurs = ″15″>

<simpleType>

<restriction base = ″string″ length value

= ″93″/>

</restriction>

</simpleType>

<element name = ″CBEM_repetition_period″ type =

″hexBinary″/>

<element name =

″CBEM_number_of_broadcasts_requested″

type = ″hexBinary″/>

<element name = ″CBEM_CBS_Geotargeting_Info″

minOccurs = ″0″

maxOccurs = ″unbounded″>
<complexType>

<sequence>

<element name = ″CBEM_geocode_type″>

<<simpleType>

<restriction base = ″string″>

<enumeration value = “CMAS″/>
<enumeration value = ″SAME″/>
<enumeration value = ″FIPS″/>
<enumeration value = ″ZIP″/>

</restriction>

</simpleType>

```
  </element>
  <element name = ″CBEM_geocode″ type=
```

″string”

maxOccurs = ″unbounded″/>

<element name = ″CBEM_polygon″ type =

″string″

minOccurs = ″0″ maxOccurs =

″unbounded″/>

<element name = ″CBEM_circle″ type =

“string″

minOccurs = ″0″ maxOccurs =

″unbounded″/>

<element name = ″CBEM_gnis″ type =

“string″

minOccurs = ″0″ maxOccurs =

″unbounded″/>

</sequence>

</complexType>

</complexType>

</element>

</sequence>

</complexType>

</element>

<element name = ″valueName″ type = ″string″/>
<element name = ″value″ type = ″string″/>

</schema>

As previously described, the CBC can respond to the CBE. For example, as described with reference to FIG. 3, step 24, the CBC can respond to the CBE with an acknowledgement of a request message. And, as another example, with reference to FIG. 4, step 36, the CBC can respond to the CBE with an error message. Table 5 below describes example response codes and the response descriptions that can be sent by the CBC to the CBE. Message acknowledgement is accomplished with a message type of “Ack” which does not contain the conditional elements for response code and response description. The response codes and associated descriptions listed below are used in the response codes and resources descriptions of the “Error” message type.

TABLE 5
DESCRIPTION OF CBE MESSAGE RESPONSE CODES

| | RESPONSE DESCRIPTION INCLUDED | |
|---|---|---|
| RESPONSE | IN CBEM_RESPONSE_DESCRIPTION | |
| CODE | ELEMENT | NOTES |
| 100 | invalid-CBE-id | The sending CBE identifier is not valid. |
| 101 | protocol-version-not-supported | The CBC does not support the indicated |
| | | protocol version |
| 102 | server-error | General error in the CBC server |
| 103 | invalid-format | The received XML has an invalid format |
| 104 | invalid-element XXX | XXX replaced with the name of the invalid |
| | | element |
| 105 | missing-element XXX | XXX replaced with name of missing element |
| 106 | operation-not-allowed | The requested operation is not allowed |
| 107 | missing-geo-targeting-area | No geo-targeting information element |
| | | provided in the CBEM geo-targeting |
| | | segment |

As previously described, with reference to FIG. 3, step 20, and FIG. 4, step 32, as part of the communication between the CBE and the CBC, the CBE can send request messages to the CBC. Example request messages include an initial request message, an update request message, and a cancel request message. In an example embodiment, a CBE to CBC Initial Request Message comprises a CBE message containing one CBEM_CBS_Request segment, one CBEM_CBS_Message_Info segment, and one or more CBEM_CBS_Geotargeting_Info segments. Table 6 below contains a description of example CBE message elements of the CBEM_CBS_Request segment for an initial request message from the CBE to the CBC:

TABLE 6
ELEMENTS OF CBEM_CBS_REQUEST SEGMENT FOR INITIAL
REQUEST MESSAGE

| CBEM ELEMENT | VALUE |
|---|---|
| CBEM_protocol_version | Per Table 2 |
| CBEM_sender_id | Identifies the CBE which initiated |
| | the CBEM message. |
| CBEM_message_number | Per Table 2 |
| CBEM_message_type | Value of “CBS Request”. |

Table 7 below contains a description of example CBE message elements of the CBEM_CBS_Message_Info segment for an initial request message from the CBE to the CBC.

TABLE 7
ELEMENTS OF CBEM_CBS_MESSAGE_INFO SEGMENT
FOR INITIAL REQUEST MESSAGE

| CBEM ELEMENT | VALUE |
|---|---|
| CBEM_CBS_message_id | Per Table 3 |
| CBEM_data_coding_scheme | Per Table 3 |
| CBEM_language | Per Table 3 |
| CBEM_CBS_page | Per Table 3 |
| CBEM_repetition_period | Per Table 3 |
| CBEM_number_of_broadcasts_requested | Per Table 3 |

Table 8 below contains a description of example CBE message elements of the CBEM_CBS_Geotargeting_Info segment for an initial request message from the CBE to the CBC. Note that the values listed in Table 8 refer to corresponding CBEM Definition sections of Table 4.

TABLE 8
ELEMENTS OF CBEM_CBS_GEOTARGETING_INFO
SEGMENT FOR INITIAL REQUEST MESSAGE

| CBEM ELEMENT | VALUE |
|---|---|
| CBEM_geocode_type | Per Table 4 |
| CBEM_geocode | Per Table 4 |
| CBEM_polygon | Per Table 4 |
| CBEM_circle | Per Table 4 |
| CBEM_gnis | Per Table 4 |

The following is an example CMAS initial request message from the CBE to the CBC in XML format:

<?xml version = “1.0” encoding = “UTF-8”?>
<CMA_CBS_Request xmlns = “urn:xxx:xxx:xx:xxx:cbem:1.0”>

<CBEM_protocol_version>1.0</CBEM_protocol_version>
<CBEM_sender_id>http://at_cmsp_gateway.com</CBEM_sender_id>
<CBEM_message_number>ATT-CMSP-Gateway-2008-

1056</CBEM_message_number>

<CBEM_message_type>CBS Request</CBEM_message_type>

<CBEM_CBS_Message_Info>

<CBEM_CBS_message_id>4373</CBEM_CBS_message_id>
<CBEM_data_coding_scheme>GSM_7_Bit_Coding</CBEM_{—}

data_coding_scheme>

<CBEM_language>English</CBEM_ language>
<CBEM_CBS_page>Severe Weather Warning in this area until

4:15pm MST NWS</CBEM_ CBS_page>

<CBEM_repetition_period>500</CBEM_repetition_period>

<CBEM_number_of_broadcasts_requested>50</CBEM_number_of_broadcasts_r
equested>

<CBEM_CBS_Geotargeting_Info>

<CBEM_geocode_type>CMAS</CBEM_geocode_type>
<CBEM_geocode>004005</CBEM_geocode>

</CBEM_CBS_Geotargeting_Info>

</CBEM_CBC_Message_Info>

</CBEM_CBS_Request>

In an example embodiment, a CBE to CBC update request message comprises a CBEM message containing one CBEM_CBS_Request segment, one CBEM_CBS_Message_Info segment, and one or more CBEM_CBS_Geotargeting_Info segments. Table 9 below contains a summary of example CBEM elements of the CBEM_CBS_Request segment for an update request message from the CBEM to the CBC:

TABLE 9
ELEMENTS OF CBEM_CBS_REQUEST SEGMENT
FOR UPDATE REQUEST MESSAGE

| CBEM ELEMENT | VALUE |
|---|---|
| CBEM_protocol_version | Per Table 2 |
| CBEM_sender_id | Identifies the CBE which |
| | initiated the CBEM message. |
| CBEM_message_number | Per Table 2 |
| CBEM_referenced_message_number | Per Table 2 |
| CBEM_message_type | Value of “CBS Update |
| | Request”. |

Table 10 below describes example CBEM elements of the CBEM_CBS_Message_Info segment for an update request message from the CBE to the CBC.

TABLE 10
ELEMENTS OF CBEM_CBS_MESSAGE_INFO
SEGMENT FOR UPDATE REQUEST MESSAGE

| CBEM ELEMENT | VALUE |
|---|---|
| CBEM_CBS_message_id | Per Table 3 |
| CBEM_data_coding_scheme | Per Table 3 |
| CBEM_language | Per Table 3 |
| CBEM_CBS_page | Per Table 3 |
| CBEM_repetition_period | Per Table 3 |
| CBEM_number_of_broadcasts_requested | Per Table 3 |

Table 11 below describes example CBE message elements of the CBEM_CBS_Geotargeting_Info segment for an update request message from the CBE to the CBC.

TABLE 11
ELEMENTS OF CBEM_CBS_GEOTARGETING_INFO
SEGMENT FOR UPDATE REQUEST MESSAGE

| CBEM ELEMENT | VALUE |
|---|---|
| CBEM_geocode_type | Per Table 4 |
| CBEM_geocode | Per Table 4 |
| CBEM_polygon | Per Table 4 |
| CBEM_circle | Per Table 4 |
| CBEM_gnis | Per Table 4 |

The following is an example CMAS update message from the CBE to the CBC in XML format.

<?xml version = “1.0” encoding = “UTF-8”?>
<CMA_CBS_Request_xmlns = “urn:xxx:xxx:xx:xxx:cmad:1.0”>

<CBEM_protocol_version>1.0</CBEM_protocol_version>
<CBEM_message_number>ATT-CMSP-Gateway-2008-

1087</CBEM_message_number>

<CBEM_referenced_message_number>ATT-CMSP-Gateway-2008-

1056</CBEM_referenced_message_{—}
number>

<CBEM_sender_id>http://att_cmsp_gateway.com</CBEM_sender_id>
<CBEM_message_type>CBS Update Request</CBEM_message_type>
<CBEM_CBS_Message_Info>

<CBEM_CBS_message_id>4373</CBEM_CBS_message_id>
<CBEM_data_coding_scheme>GSM_7_Bit_Coding</CBEM_{—}

data_coding_scheme>

<CBEM_language>English</CBEM_ language>
<CBEM_CBS_page>Severe Weather Warning in this area until

7:15pm MST NWS</ CBEM_ CBS_page>

<CBEM_repetition_period>500</CBEM_repetition_period>

<CBEM_number_of_broadcasts_requested>50</CBEM_number_of_broadcasts_r
equested>

<CBEM_CBS_Geotargeting_Info>

<CBEM_geocode_type>CMAS</CBEM_geocode_type>
<CBEM_geocode>004005</CBEM_geocode>

</CBEM_CBS_Geotargeting_Info>

</CBEM_CBC_Message_Info>

</CBEM_CBS_Request>

In an example embodiment, a CBE to CBC cancel message comprises a CBE message containing one CBEM_CBS_Request segment. Table 12 below describes example CBEM elements of the CBEM_CBS_Request segment.

TABLE 12
ELEMENTS OF CBEM_CBS_REQUEST SEGMENT FOR CANCEL
MESSAGE

| CBEM ELEMENT | VALUE |
|---|---|
| CBEM_protocol_version | Per Table 2 |
| CBEM_sender_id | Identifies the CBE which |
| | initiated the CBEM message. |
| CBEM_message_number | Per Table 2 |
| CBEM_referenced_message_number | Per Table 2 |
| CBEM_message_type | Value of “CBS Cancel”. |

The following is an example CMAS cancellation message from the CBE to the CBC in XML format:

<?xml version = “1.0” encoding = “UTF-8”?>
<CMA_CBS_Request xmlns = “urn:xxx:xxx:xx:xxx:cmad:1.0”>

<CBEM_protocol version>1.0</CBEM_protocol_version>
<CBEM_sender_id>http://att_cmsp_gateway.com</CBEM_sender_id>
<CBEM_message_type>CBS Cancel</CBEM_message_type>
<CBEM_message_number>ATT-CMSP-Gateway-2008-1087</CBEM_message_number>
<CBEM_referenced_message_number>ATT-CMSP-Gateway-2008-

1056</CBEM_referenced_message_{—}
number>
</CBEM_CBS_Request>

In an example embodiment, an acknowledgement message sent from the CBC to the CBE comprises a CBEM message containing one CBEM_CBS_Request segment. Table 13 below describes example CBE message elements of the CBEM_CBS_Request segment.

TABLE 13
ELEMENTS OF CBEM_CBS_REQUEST SEGMENT FOR
ACKNOWLEDGEMENT RESPONSE MESSAGE

| CBEM ELEMENT | VALUE |
|---|---|
| CBEM_protocol_version | Per Table 2 |
| CBEM_sender_id | Identifies the CBE which |
| | initiated the CBEM message. |
| CBEM_message_number | Per Table 2 |
| CBEM_referenced_message_number | Per Table 2 |
| CBEM_message_type | Value of “Ack”. |

The following is an example CMAS acknowledgement response message from the CBC to the CBE in XML format:

<?xml version = “1.0” encoding = “UTF-8”?>
<CMA_CBS_Request xmlns = “urn:xxx:xxx:xx:xxx:cbem:1.0”>

<CBEM_protocol_version>1.0</CBEM_protocol_version>

<CBEM_sender_id>http://att_cell_broadcast_center.com</CBEM_sen
der_id>

<CBEM_message_type>Ack</CBEM_message_type>
<CBEM_message_number>ATT-CBC-2008-

1095</CBEM_message_number>
</CBEM_CBS_Request>

In an example embodiment, an error response message sent from the CBC to the CBE comprises a CBEM message containing one CBEM_CBS_Request segment. Table 14 below describes example CBE message elements of the CBEM_CBS_Request segment.

TABLE 14
ELEMENTS OF CBEM_CBS_REQUEST SEGMENT FOR ERROR
RESPONSE MESSAGE

| CBEM ELEMENT | VALUE |
|---|---|
| CBEM_protocol_version | Per Table 2 |
| CBEM_sender_id | Identifies the CBE which |
| | initiated the CBEM message. |
| CBEM_message_number | Per Table 2 |
| CBEM_referenced_message_number | Per Table 2 |
| CBEM_message_type | Value of “Error”. |
| CBEM_response_code | Per Table 5 |
| CBEM_response_description | Per Table 5 |

The following is an example CMAS error response message from the CBC to the CBE in XML format:

<?xml version = “1.0” encoding = “UTF-8”?>
<CMA_CBS_Request xmlns = “urn:xxx:xxx:xx:xxx:cmad:1.0”>

<CBEM_protocol_version>1.0</CBEM_protocol_version>

<CBEM_sender_id>http://att_cell_broadcast_center.com</CBEM_sender_id
>

<CBEM_message_type>Error</CBEM_message_type>
<CBEM_message number>ATT-CMSP-Gateway-2008-

1097</CBEM_message_number>

<CBEM_response_code>103</CBEM_response_code>
<CBEM_response_description>invalid-

format</CBEM_response_description>
</CBEM_CBS_Request>

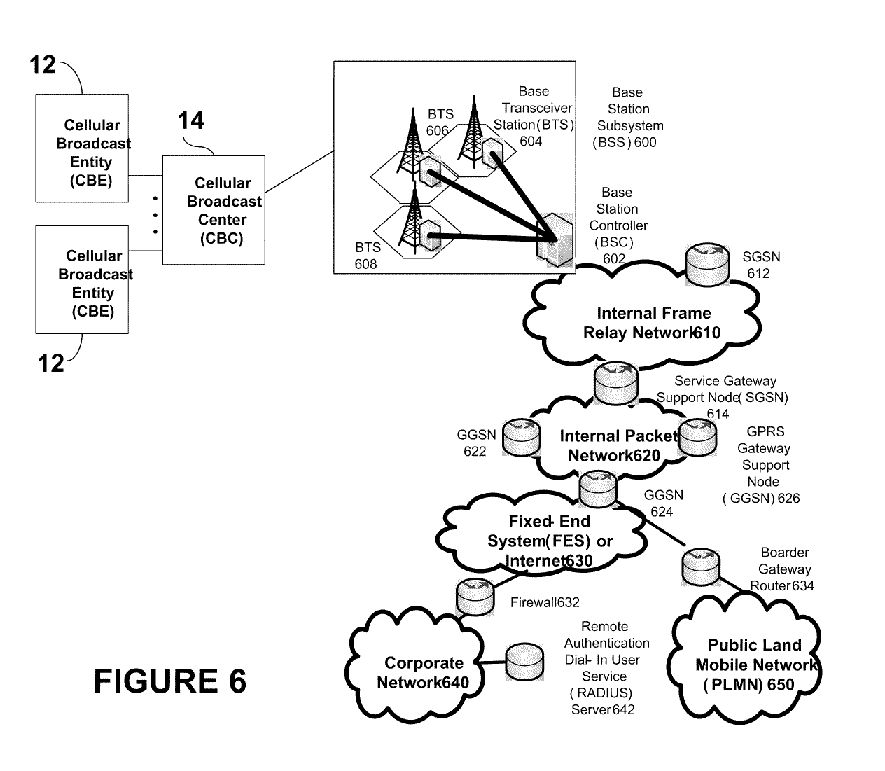

FIG. 6 depicts an overall block diagram of an exemplary packet-based mobile cellular network environment, such as a GPRS network, in which communications between a CBE 12 and a CBC 14 in accordance with the above-described XLM-based protocol can be implemented. In such an environment, there are a plurality of Base Station Subsystems (“BSS”) 600 (only one is shown), each of which comprises a Base Station Controller (“BSC”) 602 serving a plurality of Base Transceiver Stations (“BTS”) such as BTSs 604, 606, and 608. As depicted in FIG. 6, the CBE 12 is in communications with the CBC 14 utilizing the above-described XML-based protocol. The CBC 14 is in communications with the BSS 600. In an example embodiment, the interface between the CBC and BTS is a command and response interface, in which the CBC provides cell broadcast information to the BTS via a WRITE-REPLACE operation with the BTS providing responses that indicate the results of the requested Cell Broadcast operations. BTSs 604, 606, 608, etc. are the access points where users of packet-based mobile devices become connected to the wireless network. In exemplary fashion, the packet traffic originating from user devices is transported via an over-the-air interface to a BTS 608, and from the BTS 608 to the BSC 602. Base station subsystems, such as BSS 600, are a part of internal frame relay network 610 that can include Service GPRS Support Nodes (“SGSN”) such as SGSN 612 and 614. Each SGSN is connected to an internal packet network 620 through which a SGSN 612, 614, etc. can route data packets to and from a plurality of gateway GPRS support nodes (GGSN) 622, 624, 626, etc. As illustrated, SGSN 614 and GGSNs 622, 624, and 626 are part of internal packet network 620. Gateway GPRS serving nodes 622, 624 and 626 mainly provide an interface to external Internet Protocol (“IP”) networks such as Public Land Mobile Network (“PLMN”) 650, corporate intranets 640, or Fixed-End System (“FES”) or the public Internet 630. As illustrated, subscriber corporate network 640 may be connected to GGSN 624 via firewall 632; and PLMN 650 is connected to GGSN 624 via boarder gateway router 634. The Remote Authentication Dial-In User Service (“RADIUS”) server 642 may be used for caller authentication when a user of a mobile cellular device calls corporate network 640.

Generally, there can be a several cell sizes in a GSM network, referred to as macro, micro, pico, femto and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. Femto cells have the same size as pico cells, but a smaller transport capacity. Femto cells are used indoors, in residential, or small business environments. On the other hand, umbrella cells are used to cover shadowed regions of smaller cells and fill in gaps in coverage between those cells.

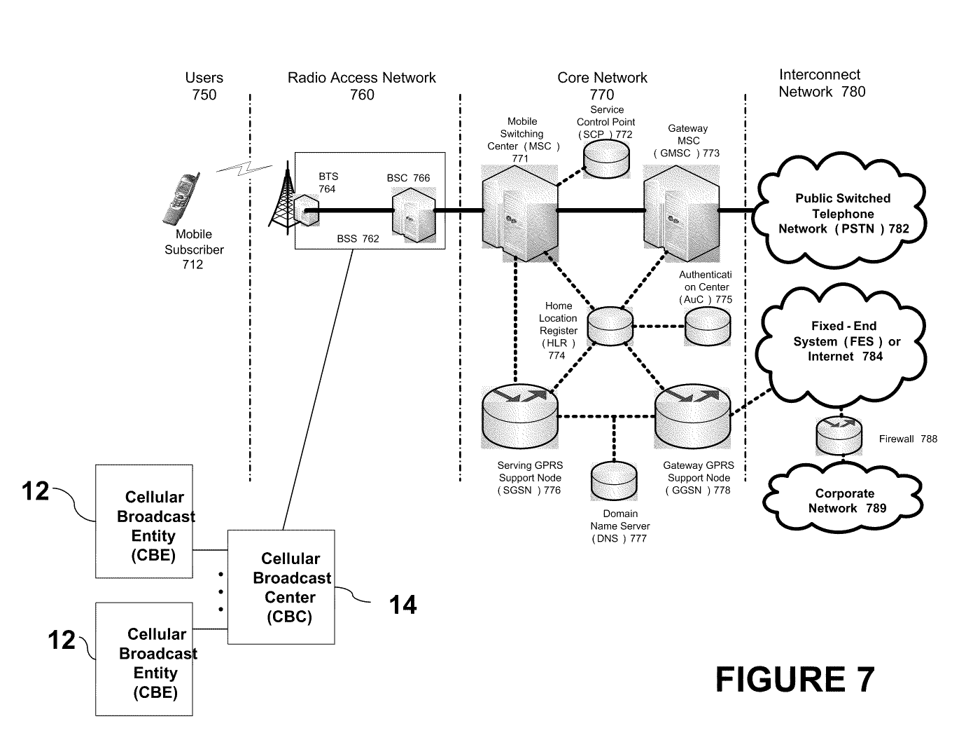

FIG. 7 illustrates an architecture of a typical GPRS network in which communications between a CBE 12 and a CBC 14 in accordance with the above-described XLM-based protocol can be implemented. The architecture depicted in FIG. 7 is segmented into four groups: users 750, radio access network 760, core network 770, and interconnect network 780. Users 750 comprise a plurality of end users. Note, device 712 is referred to as a mobile subscriber in the description of network shown in FIG. 7. In an example embodiment, the device depicted as mobile subscriber 712 comprises a mobile device. Radio access network 760 comprises a plurality of base station subsystems such as BSSs 762, which include BTSs 764 and BSCs 766. In an example embodiment, the interface between the CBC and BTS is a command and response interface, in which the CBC provides cell broadcast information to the BTS via a WRITE-REPLACE operation with the BTS providing responses that indicate the results of the requested Cell Broadcast operations. Core network 770 comprises a host of various network elements. As illustrated here, core network 770 may comprise Mobile Switching Center (“MSC”) 771, Service Control Point (“SCP”) 772, gateway MSC 773, SGSN 776, Home Location Register (“HLR”) 774, Authentication Center (“AuC”) 775, Domain Name Server (“DNS”) 777, and GGSN 778. Interconnect network 780 also comprises a host of various networks and other network elements. As illustrated in FIG. 7, interconnect network 780 comprises Public Switched Telephone Network (“PSTN”) 782, Fixed-End System (“FES”) or Internet 784, firewall 788, and Corporate Network 789.

A mobile switching center can be connected to a large number of base station controllers. At MSC 771, for instance, depending on the type of traffic, the traffic may be separated in that voice may be sent to Public Switched Telephone Network (“PSTN”) 782 through Gateway MSC (“GMSC”) 773, and/or data may be sent to SGSN 776, which then sends the data traffic to GGSN 778 for further forwarding.

When MSC 771 receives call traffic, for example, from BSC 766, it sends a query to a database hosted by SCP 772. The SCP 772 processes the request and issues a response to MSC 771 so that it may continue call processing as appropriate.

The HLR 774 is a centralized database for users to register to the GPRS network. HLR 774 stores static information about the subscribers such as the International Mobile Subscriber Identity (“IMSI”), subscribed services, and a key for authenticating the subscriber. HLR 774 also stores dynamic subscriber information such as the current location of the mobile subscriber. Associated with HLR 774 is AuC 775. AuC 775 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 7, when mobile subscriber 712 initiates the attach process by turning on the network capabilities of the mobile device, an attach request is sent by mobile subscriber 712 to SGSN 776. The SGSN 776 queries another SGSN, to which mobile subscriber 712 was attached before, for the identity of mobile subscriber 712. Upon receiving the identity of mobile subscriber 712 from the other SGSN, SGSN 776 requests more information from mobile subscriber 712. This information is used to authenticate mobile subscriber 712 to SGSN 776 by HLR 774. Once verified, SGSN 776 sends a location update to HLR 774 indicating the change of location to a new SGSN, in this case SGSN 776. HLR 774 notifies the old SGSN, to which mobile subscriber 712 was attached before, to cancel the location process for mobile subscriber 712. HLR 774 then notifies SGSN 776 that the location update has been performed. At this time, SGSN 776 sends an Attach Accept message to mobile subscriber 712, which in turn sends an Attach Complete message to SGSN 776.

After attaching itself with the network, mobile subscriber 712 then goes through the authentication process. In the authentication process, SGSN 776 sends the authentication information to HLR 774, which sends information back to SGSN 776 based on the user profile that was part of the user's initial setup. The SGSN 776 then sends a request for authentication and ciphering to mobile subscriber 712. The mobile subscriber 712 uses an algorithm to send the user identification (ID) and password to SGSN 776. The SGSN 776 uses the same algorithm and compares the result. If a match occurs, SGSN 776 authenticates mobile subscriber 712.

Next, the mobile subscriber 712 establishes a user session with the destination network, corporate network 789, by going through a Packet Data Protocol (“PDP”) activation process. Briefly, in the process, mobile subscriber 712 requests access to the Access Point Name (“APN”), for example, UPS.com, and SGSN 776 receives the activation request from mobile subscriber 712. SGSN 776 then initiates a Domain Name Service (“DNS”) query to learn which GGSN node has access to the UPS.com APN. The DNS query is sent to the DNS server within the core network 770, such as DNS 777, which is provisioned to map to one or more GGSN nodes in the core network 770. Based on the APN, the mapped GGSN 778 can access the requested corporate network 789. The SGSN 776 then sends to GGSN 778 a Create Packet Data Protocol (“PDP”) Context Request message that contains necessary information. The GGSN 778 sends a Create PDP Context Response message to SGSN 776, which then sends an Activate PDP Context Accept message to mobile subscriber 712.

Once activated, data packets of the call made by mobile subscriber 712 can then go through radio access network 760, core network 770, and interconnect network 780, in a particular fixed-end system or Internet 784 and firewall 788, to reach corporate network 789.

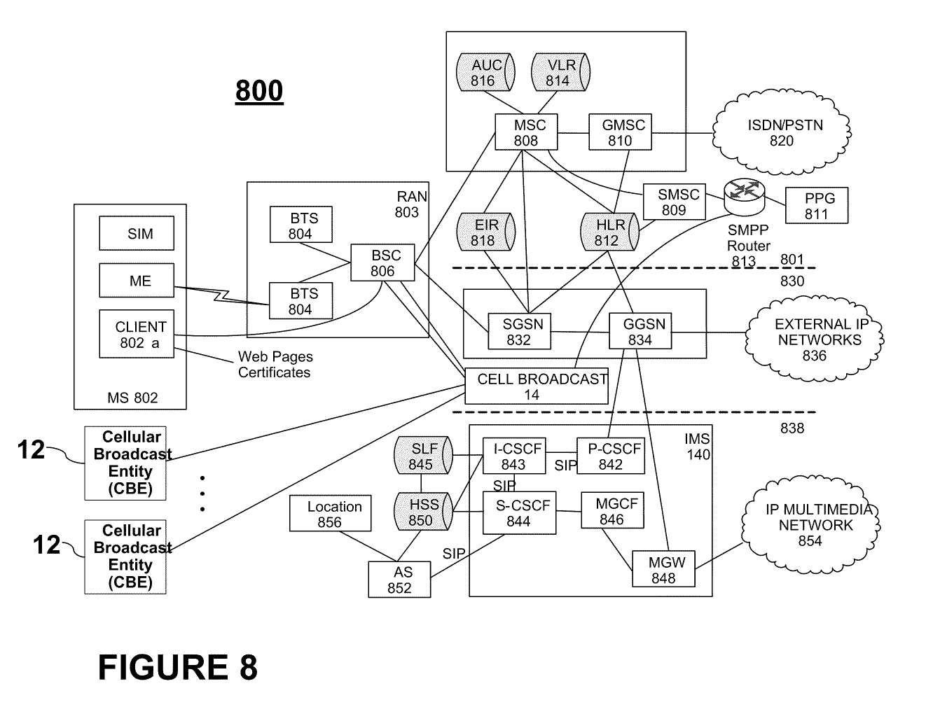

FIG. 8 illustrates an exemplary block diagram view of a GSM/GPRS/IP multimedia network architecture 800 within which communications between a CBE 12 and a CBC 14 in accordance with the above-described XLM-based protocol can be implemented. In an example embodiment the CBC is responsible for the determination of the cell sites associated with the indicated target area and for the distribution of Cell Broadcast messages to the calculated set of cell sites within the indicated target area. The CBE is the source of the information to be broadcast to an indicated target area. The CBE could be an Emergency Alert Gateway or any other appropriate information source, such as, for example, stock quotes, sports scores, weather, traffic, etc. As illustrated, architecture 800 of FIG. 8 includes a GSM core network 801, a GPRS network 830 and an IP multimedia network 838. The GSM core network 801 includes a Mobile Station (MS) 802, at least one Base Transceiver Station (BTS) 804 and a Base Station Controller (BSC) 806. The MS 802 is physical equipment or Mobile Equipment (ME), such as a mobile phone or a laptop computer that is used by mobile subscribers, with a Subscriber identity Module (SIM) or a Universal Integrated Circuit Card (UICC). The SIM or UICC includes an International Mobile Subscriber Identity (IMSI), which is a unique identifier of a subscriber. The BTS 804 is physical equipment, such as a radio tower, that enables a radio interface to communicate with the MS. Each BTS may serve more than one MS. The BSC 806 manages radio resources, including the BTS. The BSC may be connected to several BTSs. The BSC and BTS components, in combination, are generally referred to as a base station (BSS) or radio access network (RAN) 803.

The GSM core network 801 also includes a Mobile Switching Center (MSC) 808, a Gateway Mobile Switching Center (GMSC) 810, a Home Location Register (HLR) 812, Visitor Location Register (VLR) 814, an Authentication Center (AuC) 818, and an Equipment Identity Register (EIR) 816. The MSC 808 performs a switching function for the network. The MSC also performs other functions, such as registration, authentication, location updating, handovers, and call routing. The GMSC 810 provides a gateway between the GSM network and other networks, such as an Integrated Services Digital Network (ISDN) or Public Switched Telephone Networks (PSTNs) 820. Thus, the GMSC 810 provides interworking functionality with external networks.

The HLR 812 is a database that contains administrative information regarding each subscriber registered in a corresponding GSM network. The HLR 812 also contains the current location of each MS. The VLR 814 is a database that contains selected administrative information from the HLR 812. The VLR contains information necessary for call control and provision of subscribed services for each MS currently located in a geographical area controlled by the VLR. The HLR 812 and the VLR 814, together with the MSC 808, provide the call routing and roaming capabilities of GSM. The AuC 816 provides the parameters needed for authentication and encryption functions. Such parameters allow verification of a subscriber's identity. The EIR 818 stores security-sensitive information about the mobile equipment.

A Short Message Service Center (SMSC) 809 allows one-to-one Short Message Service (SMS) messages to be sent to/from the MS 802. A Push Proxy Gateway (PPG) 811 is used to “push” (i.e., send without a synchronous request) content to the MS 802. The PPG 811 acts as a proxy between wired and wireless networks to facilitate pushing of data to the MS 802. A Short Message Peer to Peer (SMPP) protocol router 813 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 802 sends a location update including its current location information to the MSC/VLR, via the BTS 804 and the BSC 806. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 830 is logically implemented on the GSM core network architecture by introducing two packet-switching network nodes, a serving GPRS support node (SGSN) 832, a cell broadcast and a Gateway GPRS support node (GGSN) 834. The SGSN 832 is at the same hierarchical level as the MSC 808 in the GSM network. The SGSN controls the connection between the GPRS network and the MS 802. The SGSN also keeps track of individual MS's locations and security functions and access controls.

A Cell Broadcast Center (CBC) 14 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 834 provides a gateway between the GPRS network and a public packet network (PDN) or other IP networks 836. That is, the GGSN provides interworking functionality with external networks, and sets up a logical link to the MS through the SGSN. When packet-switched data leaves the GPRS network, it is transferred to an external TCP-IP network 836, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 630 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel In a NOM3 network, a MS can monitor pages for a circuit switched network while received data and vise versa.

The IP multimedia network 638 was introduced with 3GPP Release 5, and includes an IP multimedia subsystem (IMS) 640 to provide rich multimedia services to end users. A representative set of the network entities within the IMS 640 are a call/session control function (CSCF), a media gateway control function (MGCF) 646, a media gateway (MGW) 648, and a master subscriber database, called a home subscriber server (HSS) 650. The HSS 650 may be common to the GSM network 601, the GPRS network 630 as well as the IP multimedia network 638.

The IP multimedia system 640 is built around the call/session control function, of which there are three types: an interrogating CSCF (I-CSCF) 643, a proxy CSCF (P-CSCF) 642, and a serving CSCF (S-CSCF) 644. The P-CSCF 642 is the MS's first point of contact with the IMS 640. The P-CSCF 642 forwards session initiation protocol (SIP) messages received from the MS to an SIP server in a home network (and vice versa) of the MS. The P-CSCF 642 may also modify an outgoing request according to a set of rules defined by the network operator (for example, address analysis and potential modification).

The I-CSCF 643, forms an entrance to a home network and hides the inner topology of the home network from other networks and provides flexibility for selecting an S-CSCF. The I-CSCF 643 may contact a subscriber location function (SLF) 645 to determine which HSS 650 to use for the particular subscriber, if multiple HSS's 650 are present. The S-CSCF 644 performs the session control services for the MS 602. This includes routing originating sessions to external networks and routing terminating sessions to visited networks. The S-CSCF 644 also decides whether an application server (AS) 652 is required to receive information on an incoming SIP session request to ensure appropriate service handling. This decision is based on information received from the HSS 650 (or other sources, such as an application server 652). The AS 652 also communicates to a location server 656 (e.g., a Gateway Mobile Location Center (GMLC)) that provides a position (e.g., latitude/longitude coordinates) of the MS 602.

The HSS 650 contains a subscriber profile and keeps track of which core network node is currently handling the subscriber. It also supports subscriber authentication and authorization functions (AAA). In networks with more than one HSS 650, a subscriber location function provides information on the HSS 650 that contains the profile of a given subscriber.

The MGCF 646 provides interworking functionality between SIP session control signaling from the IMS 640 and ISUP/BICC call control signaling from the external GSTN networks (not shown). It also controls the media gateway (MGW) 648 that provides user-plane interworking functionality (e.g., converting between AMR- and PCM-coded voice). The MGW 648 also communicates with other IP multimedia networks 654.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

While example embodiments of and XML-based protocol for communications between a CBE and a CBC have been described in connection with various computing devices/processor, the underlying concepts can be applied to any computing device, processor, or system capable of utilizing and/or implementing an XML-based protocol for communications between a CBE and a CBC. The various techniques described herein can be implemented in connection with hardware or software or, where appropriate, with a combination of both. Thus, the methods and apparatuses for the utilization an XML-based protocol for communications between a CBE and a CBC, or certain aspects or portions thereof, can take the form of program code (i.e., instructions) embodied in tangible storage media, such as floppy diskettes, CD-ROMs, hard drives, or any other machine-readable storage medium, wherein, when the program code is loaded into and executed by a machine, such as a computer, the machine becomes an apparatus for the utilization of an XML-based protocol for communications between a CBE and a CBC. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for implementing and using an XML-based protocol for communications between a CBE and a CBC also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for the utilization of on-demand spam reporting. When implemented on a general-purpose processor, the program code combines with the processor to provide a unique apparatus that operates to invoke the functionality of an XML-based protocol for communications between a CBE and a CBC. Additionally, any storage techniques used in connection with the utilization of an XML-based protocol for communications between a CBE and a CBC can invariably be a combination of hardware and software.

While an XML-based protocol for communications between a CBE and a CBC reporting has been described in connection with the various embodiments of the various figures, it is to be understood that other similar embodiments can be used or modifications and additions can be made to the described embodiment for performing the same function of utilizing an XML-based protocol for communications between a CBE and a CBC without deviating therefrom. For example, one skilled in the art will recognize that the utilization of an XML-based protocol for communications between a CBE and a CBC as described in the present application may apply to any environment, whether wired or wireless, and may be applied to any number of such devices connected via a communications network and interacting across the network. Therefore, an XML-based protocol for communications between a CBE and a CBC should not be limited to any single embodiment, but rather should be construed in breadth and scope in accordance with the appended claims.

What is claimed:

1. A method for communicating between a cellular broadcast entity (CBE) and a cellular broadcast center (CBC) utilizing an extensible markup language (XML)-based protocol, the method comprising:
constructing, via the CBE, an XML structured first message;
sending, from the CBE to the CBC, the first message;
receiving, by the CBC, the first message;
determining, via the CBC if the received first message is valid; and
constructing, via the CBC, an XML structured second message, wherein:
if it is determined that the received first message is valid, the second message indicates acknowledgement of the received first message; and
if it is determined that the received first message is invalid, the second message indicates an error message.

2. The method in accordance with claim 1, wherein the first message comprises an indication of an Emergency Alert System message.

3. The method in accordance with claim 1, wherein the first message comprises one of:
an indication to initiate a broadcast of a cellular broadcast message;
an indication to update a cellular broadcast message; or
an indication to cancel a cellular broadcast message.

4. The method in accordance with claim 1, wherein the first message comprises an indication to initiate a broadcast of a cellular broadcast message and comprises at least one of:
a first message segment indicating a request to initiate the broadcast of the cellular broadcast message;
a second message segment comprising information pertaining to the broadcast of the cellular broadcast message; and
a third message segment comprising an indication of a geographic location associated with the cellular broadcast message.

5. The method in accordance with claim 4, wherein:
the first message segment comprises at least one of:
a namespace of the first message;
a version of the XML protocol of the first message;
a message number of the first message;
an indication of the sender of the first message; or
an indication of a message type of the first message; and
the second message segment comprises at least one of:
a message ID of the first message;
an indication of coding utilized for characters of the first message;
an indication of a language of the first message;
an indication of a number of pages of the cellular broadcast message;
an indication of a repetition period of the cellular broadcast message; or
an indication of a number of times the cellular broadcast message is to be broadcast.

6. The method in accordance with claim 4, wherein the third message segment comprises a geographic code delineating a cellular broadcast area comprising at least one of:
a CMAS geocode;
a SAME code;
a FIPS code; or
a ZIP code.

7. The method in accordance with claim 1, wherein the first message comprises an indication to update a cellular broadcast message and comprises at least one of:
a first message segment indicating a request to update the broadcast of the cellular broadcast message;
a second message segment comprising information pertaining to the broadcast of the cellular broadcast message; and
a third message segment comprising an indication of a geographic location associated with the cellular broadcast message.

8. The method in accordance with claim 1, wherein the first message comprises an indication to cancel a cellular broadcast message and comprises a message segment indicating a request to cancel the broadcast of the cellular broadcast message.

9. A cellular broadcast entity (CBE) configured to communicate with a cellular broadcast center (CBC) utilizing an extensible markup language (XML)-based protocol, the CBE configure to:
construct an XML structured first message;
send, to the CBC, the first message;
receive, from the CBC, an XML structured second message indicating one of:
acknowledgement that the first message was received by the CBC and was determined to be valid, or
an error message indicating that the first message was received by the CBC and was determined to be invalid.

10. The CBE in accordance with claim 9, wherein the first message comprises an indication of an Emergency Alert System message.

11. The CBE in accordance with claim 9, wherein the first message comprises one of:
an indication to initiate a broadcast of a cellular broadcast message;
an indication to update a cellular broadcast message; or
an indication to cancel a cellular broadcast message.

12. The CBE in accordance with claim 9, wherein the first message comprises an indication to initiate a broadcast of a cellular broadcast message and comprises at least one of:
a first message segment indicating a request to initiate the broadcast of the cellular broadcast message;
a second message segment comprising information pertaining to the broadcast of the cellular broadcast message; and
a third message segment comprising an indication of a geographic location associated with the cellular broadcast message.

13. The CBE in accordance with claim 12, wherein:
the first message segment comprises at least one of:
a namespace of the first message;
a version of the XML protocol of the first message;
a message number of the first message;
an indication of the sender of the first message; or
an indication of a message type of the first message; and
the second message segment comprises at least one of:
a message ID of the first message;
an indication of coding utilized for characters of the first message;
an indication of a language of the first message;
an indication of a number of pages of the cellular broadcast message;
an indication of a repetition period of the cellular broadcast message; or
an indication of a number of times the cellular broadcast message is to be broadcast.

14. The CBE in accordance with claim 12, wherein the third message segment comprises a geographic code delineating a cellular broadcast area comprising at least one of:
a CMAS geocode;
a SAME code;
a FIPS code; or
a ZIP code.

15. The CBE in accordance with claim 9, wherein the first message comprises an indication to update a cellular broadcast message and comprises at least one of:
a first message segment indicating a request to update the broadcast of the cellular broadcast message;
a second message segment comprising information pertaining to the broadcast of the cellular broadcast message; and
a third message segment comprising an indication of a geographic location associated with the cellular broadcast message.

16. The CBE in accordance with claim 9, wherein the first message comprises an indication to cancel a cellular broadcast message and comprises a message segment indicating a request to cancel the broadcast of the cellular broadcast message.
